(19) United States
(12) Patent Application Publication
(10) Pub. No.: US 2013/0041838 A1
(43) Pub. Date: Feb. 14, 2013

(54) SYSTEM AND METHOD FOR ANALYZING CONTACT CENTER METRICS FOR A HETEROGENEOUS CONTACT CENTER

(71) Applicants: Luciano Godoy Fagundes, Sao Paulo (BR); Thomas J. Moran, Galway (IE); Veeranna A. Yamanappa, Pune (IN); Mohammad Khan, Pune (IN); Dhaval Desai, Pune (IN); Joylee E. Kohler, Northglenn, CO (US)

(72) Inventors: Luciano Godoy Fagundes, Sao Paulo (BR); Thomas J. Moran, Galway (IE); Veeranna A. Yamanappa, Pune (IN); Mohammad Khan, Pune (IN); Dhaval Desai, Pune (IN); Joylee E. Kohler, Northglenn, CO (US)

(73) Assignee: Avaya Inc., Basking Ridge, NJ (US)

(21) Appl. No.: 13/207,502

(22) Filed: Aug. 11, 2011

(51) Int. Cl. G06Q 30/00; G06N 7/02

(52) U.S. Cl. 705/347; 706/47

(57) ABSTRACT

Provided herein is a system and method to produce a composite rating using context information. The method may include: measuring a first and a second metric in a first and a second context respectively, to provide a first and a second contextual measurement, respectively; transforming the first contextual measurement to a first plurality of semantic context values by use of a first plurality of pertaining functions; transforming the second contextual measurement to a second plurality of semantic context values by use of a second plurality of pertaining functions; combining one or more of the first plurality of semantic context values and one or more of the second plurality of semantic context values, by use of one or more fuzzy logic rules, to produce a plurality of semantic distributions; and calculating a centroid of a merger of the plurality of semantic distributions in order to produce the composite rating.

### BACKGROUND

1. Field of the Invention

Embodiments of the present invention generally relate to systems and methods for analyzing calling center metrics with their contexts in order to generate contextually rich values, and, in particular, to generate contextually rich values that are measurable and comparable among heterogeneous contact centers.

2. Description of Related Art

Call centers are commonly used by service providers or manufacturers (collectively, “vendors”) to provide customer support. Customers requesting customer support may contact the call center by telephone. As additional methods of communication between agent and customer have been developed such as, but not limited to, e-mail, instant messaging, web chat, and so forth, call centers have evolved into contact centers in order to handle communication by a variety of methods, i.e., beyond telephone calls. An instance of a customer contacting a contact by any of these methods will be referred to herein as a customer contact. In contact centers, quickly finding and assigning a well-qualified service agent to service and fulfill a customer's need is important in providing improved customer satisfaction.

A metric is known as a quantitative measurement of a parameter that is important to performance of a system. The current contact center metrics are very low level and provide details about a small portion of the contact center system. The metric is valid within a limited context (e.g., what functional department collected the metric). The context in which a metric is collected is referred to herein as contextually rich information. The context is important to evaluating the metric. For instance, a two minute talk time could be considered bad for a collections department but could be reasonable for a customer support service department. However, known systems do not provide contextually rich information, therefore it is difficult to compare metric sets among different contact centers or even among different teams inside the same contact center.

Metrics analysis has been used as a way to expand a single performance measurement. For instance, total handling time may include Total Talk Time+Total Hold Time+Total Wrap-up time. Expanding a performance measurement this way may make it easier for users to find certain information, but it adds no contextual information to the metric itself regarding how good or bad that number is for the organization. Without contextual information, the expanded performance measurement still cannot be comparable among different functional departments because the same measurement value may mean different things for different users. Due to lack of contextual information, users currently may create ad hoc metric sets and methods to normalize information across contexts in order to compare results in a heterogeneous contact center.

Therefore, a need exists to provide improved normalization of performance metrics by use of their contexts, in order to be able to compare metrics across contexts within a heterogeneous contact center, and ultimately to provide improved customer satisfaction.

### SUMMARY

Embodiments of the present invention generally relate to systems and methods for analyzing calling center metrics with their contexts in order to generate contextually rich values, and, in particular, to an improved system and method for analyzing calling center metrics with their contexts in order to generate contextually rich values that are measurable and comparable among heterogeneous contact centers.

In one embodiment of the present invention, a method to produce a composite rating using context information includes: measuring a first metric in a first context to provide a first contextual measurement; measuring a second metric in a second context to provide a second contextual measurement; transforming the first contextual measurement to a first plurality of semantic context values by use of a first plurality of pertaining functions; transforming the second contextual measurement to a second plurality of semantic context values by use of a second plurality of pertaining functions; combining one or more of the first plurality of semantic context values and one or more of the second plurality of semantic context values, by use of one or more fuzzy logic rules, to produce a plurality of semantic distributions; and calculating a centroid of a merger of the plurality of semantic distributions in order to produce the composite rating.

In one embodiment of the present invention, a system to produce a rating using heterogeneous context information includes: a first measurement module configured to measure a first metric in a first context to provide a first contextual measurement; a second measurement module configured to measure a second metric in a second context to provide a second contextual measurement; a first transformation module configured to transform the first contextual measurement to a first plurality of semantic context values by use of a first plurality of pertaining functions; a second transformation module configured to transform the second contextual measurement to a second plurality of semantic context values by use of a second plurality of pertaining functions; a combiner configured to combine one or more of the first plurality of semantic context values and one or more of the second plurality of semantic context values, by use of one or more fuzzy logic rules, to produce a plurality of semantic distributions; and a processor configured to calculate a centroid of a merger of the plurality of semantic distributions in order to produce the composite rating.

In one embodiment of the present invention, a system, includes a computer server, the computer server comprising a tangible computer readable medium comprising program instructions, wherein the program instructions are computer-executable to implement the steps of: measuring a first metric in a first context to provide a first contextual measurement; measuring a second metric in a second context to provide a second contextual measurement; transforming the first contextual measurement to a first plurality of semantic context values by use of a first plurality of pertaining functions; transforming the second contextual measurement to a second plurality of semantic context values by use of a second plurality of pertaining functions; combining one or more of the first plurality of semantic context values and one or more of the second plurality of semantic context values, by use of one or more fuzzy logic rules, to produce a plurality of semantic distributions; and calculating a centroid of a merger of the plurality of semantic distributions in order to produce the composite rating.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a contact center in accordance with an embodiment of the present invention;

FIG. 2 is a system level block diagram depicting an administrator server in accordance with an embodiment of the present invention;

FIG. 3 is a first pertaining function for a first metric, in accordance with an embodiment of the present invention;

FIG. 4 is a second pertaining function for a first metric, in accordance with an embodiment of the present invention;

FIG. 5 is a third pertaining function for a first metric, in accordance with an embodiment of the present invention;

FIG. 6 is a first pertaining function for a second metric, in accordance with an embodiment of the present invention;

FIG. 7 is a second pertaining function for a second metric, in accordance with an embodiment of the present invention;

FIG. 8 is a third pertaining function for a second metric, in accordance with an embodiment of the present invention;

FIG. 9 is a composite fuzzy logic relationship in accordance with an embodiment of the present invention;

FIG. 10 is an illustration of applying fuzzy logic rules, in accordance with an embodiment of the present invention;

FIG. 11 is another illustration of applying fuzzy logic rules, in accordance with an embodiment of the present invention;

FIG. 12 is another illustration of applying fuzzy logic rules, in accordance with an embodiment of the present invention; and

FIG. 13 is an illustration of merging fuzzy logic results to find a centroid, accordance with an embodiment of the present invention.

### DETAILED DESCRIPTION

Embodiments of the present invention generally relate to systems and methods for analyzing calling center metrics with their contexts in order to generate contextually rich values. More specifically, embodiments of the present invention relate to a system and method for analyzing calling center metrics with their contexts in order to generate contextually rich values that are measurable and comparable among heterogeneous contact centers.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein in connection with embodiments of the present invention, the term “contact” (as in “customer contact”) refers to a communication from a customer or potential customer, in which a request is presented to a contact center. The request can be by way of any communication medium such as, but not limited to, a telephone call, e-mail, instant message, web chat, and the like.

As used herein in connection with embodiments of the present invention, the term “customer” denotes a party external to the contact center irrespective of whether or not that party is a “customer” in the sense of having a commercial relationship with the contact center or with a business represented by the contact center. “Customer” is thus shorthand, as used in contact center terminology, for the other party to a contact or a communications session.

As used herein in connection with embodiments of the present invention, the term “metric” denotes a quantitative measurement of a parameter that is important to performance of a system. A metric may be measured and compared to a numeric scale. For instance a metric may include an objective measurement such as a waiting time, or a subjective measurement such as a quality rating, satisfaction rating, or a feedback score.

As used herein in connection with embodiments of the present invention, the term “context” or “contextually rich information” denotes information related to the measurement scope, measurement conditions, historical record, etc., of a metric.

As used herein in connection with embodiments of the present invention, the term “semantics” denotes a description that provides a comparison relative to a subjective scale (e.g., “good”, “neutral”, “bad”, etc.), without precise numeric boundaries.

The terms “switch,” “server,” “contact center server,” or “contact center computer server” as used herein should be understood to include a Private Branch Exchange (“PBX”), an ACD, an enterprise switch, or other type of telecommunications system switch or server, as well as other types of processor-based communication control devices such as, but not limited to, media servers, computers, adjuncts, and the like.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting an electrical signal.

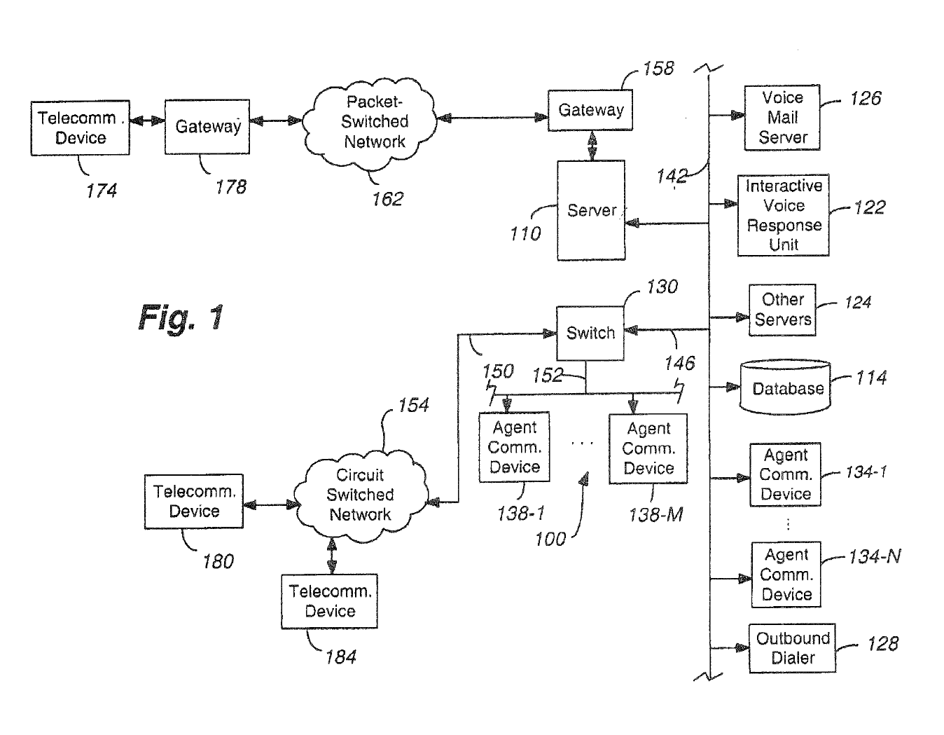

Referring now to FIG. 1, which is a block diagram depicting a contact center in accordance with an embodiment of the present invention, there is provided a contact center 100. The contact center generally comprises a central server 110, a set of data stores or databases 114 containing contact or customer related information and other information that can enhance the value and efficiency of the contact, and a plurality of servers, for example, a voice mail server 126, an Interactive Voice Response unit or “IVR” 122, and other servers 124, an outbound dialer 128, a switch 130, a plurality of working agents operating packet-switched (first) telecommunication devices 134-1 to N (such as, but not limited to, computer work stations or personal computers), and/ or circuit-switched (second) telecommunication devices 138-1 to M, all interconnected by a local area network LAN (or wide area network WAN) 142. The servers can be connected via optional communication lines 146 to the switch 130.

As will be appreciated, the other servers 124 can also include a scanner (which is normally not connected to the switch 130 or Web server), VoIP software, video call software, voice messaging software, an IP voice server, a fax server, a web server, an instant messaging server, and an email server) and the like. The switch 130 is connected via a plurality of trunks 150 to the Public Switch Telecommunication Network or PSTN 154 and via link(s) 152 to the second telecommunication devices 138-1 to M. A gateway 158 is positioned between the server 110 and the packet-switched network 162 to process communications passing between the server 110 and the network 162.

The gateway 158 may comprise Avaya Inc.'s, G250™, G350™, G430™, G450™, G650™, G700™, and IG550™ Media Gateways and may be implemented as hardware such as, but not limited to, via an adjunct processor (as shown) or as a chip in the server.

The first telecommunication devices 134-1, . . . 134-N are packet-switched device, and may include, for example, IP hardphones, such as the Avaya Inc.'s, 1600™, 4600™, and 5600™ Series IP Phones™; IP softphones, such as Avaya Inc.'s, IP Softphone™; Personal Digital Assistants or PDAs; Personal Computers or PCs, laptops; packet-based H.320 video phones and/or conferencing units; packet-based voice messaging and response units; and packet-based traditional computer telephony adjuncts.

The second telecommunication devices 138-1, . . . 138-M are circuit-switched. Each of the telecommunication devices 138-1, . . . 138-M corresponds to one of a set of internal extensions, for example, Ext1, . . . ExtM, respectively. These extensions are referred to herein as “internal” in that they are extensions within the premises that are directly serviced by the switch. More particularly, these extensions correspond to conventional telecommunication device endpoints serviced by the switch/server, and the switch/server can direct incoming calls to and receive outgoing calls from these extensions in a conventional manner.

The second telecommunication devices can include, for example, wired and wireless telephones, PDAs, H.320 video phones and conferencing units, voice messaging and response units, and traditional computer telephony adjuncts. Exemplary digital telecommunication devices include Avaya Inc.'s 2400™, 5400™, and 9600™ Series phones.

It should be noted that embodiments of the present invention do not require any particular type of information transport medium between the switch or server and the first and second telecommunication devices, i.e., embodiments of the present invention may be implemented with any desired type of transport medium as well as combinations of different types of transport media.

The packet-switched network 162 of FIG. 1 may comprise any data and/or distributed processing network such as, but not limited to, the Internet. The network 162 typically includes proxies (not shown), registrars (not shown), and routers (not shown) for managing packet flows. The packet-switched network 162 is in (wireless or wired) communication with an external first telecommunication device 174 via a gateway 178, and the circuit-switched network 154 with an external (wired) second telecommunication device 180 and (wireless) third (customer) telecommunication device 184. These telecommunication devices are referred to as “external” in that they are not directly supported as telecommunication device endpoints by the switch or server. The telecommunication devices 174 and 180 are an example of devices more generally referred to herein as “external endpoints.”

In one configuration, the server 110, network 162, and first telecommunication devices 134 are Session Initiation Protocol or SIP compatible and can include interfaces for various other protocols such as, but not limited to, the Lightweight Directory Access Protocol or LDAP, H.248, H.323, Simple Mail Transfer Protocol or SMTP, IMAP4, ISDN, E1/T1, and analog line or trunk.

It should be emphasized the configuration of the switch, server, user telecommunication devices, and other elements, as shown in FIG. 1, is for purposes of illustration only and should not be construed as limiting embodiments of the present invention to any particular arrangement of elements.

As will be appreciated, the central server 110 is notified via LAN 142 of an incoming contact by the telecommunications component (e.g., switch 130, fax server, email server, web server, and/or other server) receiving the incoming contact. The incoming contact is held by the receiving telecommunications component until the server 110 forwards instructions to the component to route, and then forward the contact to a specific contact center resource such as, but not limited to, the IVR unit 122, the voice mail server 126, the instant messaging server, and/or first or second telecommunication device 134, 138 associated with a selected agent. The server 110 distributes and connects these contacts to telecommunication devices of available agents, based on the predetermined criteria noted above.

When the central server 110 forwards a voice contact to an agent, the central server 110 also forwards customer-related information from databases 114 to the agent's computer work station for viewing (such as by a pop-up display) to permit the agent to better serve the customer. The agents process the contacts sent to them by the central server 110. This embodiment is particularly suited for a Customer Relationship Management (CRM) environment in which customers are permitted to use any media to contact a business. In the CRM environment, both real-time and non-real-time contacts may be handled and distributed with equal efficiency and effectiveness. The server 110 may use a work assignment algorithm that, for example, does not use a queue. In any event, the contact may have associated or “known” contact information. This contact information may include, for example, how long the contact has been waiting, the contact's priority, the contact's media channel, the contact's business value, etc. The contact may be handled based on such known contact information.

The server and/or switch can be a software-controlled system including a processing unit (CPU), microprocessor, or other type of digital data processor executing software or an Application-Specific Integrated Circuit (ASIC) as well as various portions or combinations of such elements. The memory may comprise random access memory (RAM), a read-only memory (ROM), or combinations of these and other types of electronic memory devices. Embodiments of the present invention may be implemented as software, hardware (such as, but not limited to, a logic circuit), or a combination thereof.

The contact center 100, in one configuration, includes an automated instant messaging server as another server 124. In such an embodiment, when a customer initiates contact with the contact center 100 using instant messaging, a new instant messaging thread is initiated by the customer. As will be appreciated, instant messages are stand-alone messages, and threading (or associating instant messages with data structures associated with an instant messaging session between a customer and an agent) occurs at the application level. The association is typically effected by pairing an electronic address (e.g., IP address, Media Access Control (MAC) address, telephone number, mobile-device identifier, and the like) of the customer's communication device with an electronic address (e.g., IP address, MAC address, telephone number, mobile-device identifier, and the like) of the agent's communication device in a manner similar to that used for a voice call.

The instant messaging server can be configured to send an automated response, such as “Please wait while I connect you with an agent” and/or to send the instant message to an automated interactive response unit for data collection. The instant messaging server subsequently notifies the server 110 of the existence of a new instant messaging contact, and the server 110 decides whether a suitable (human) agent is available. If an agent is available, the server 110 instructs the instant messaging server to redirect the instant messaging conversation to that available agent's communication device 134-1 . . . N. The server 110 routes, substantially in real-time, subsequent instant messages from the agent's communication device to the customer's communication device and from the customer's communication device to the agent's communication device.

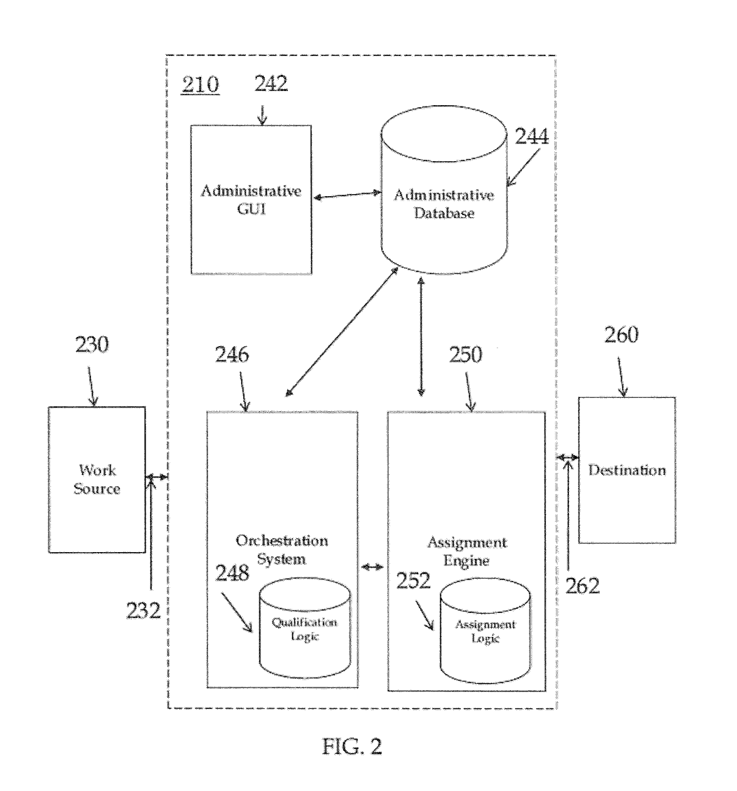

Referring to FIG. 2, which depicts a block diagram of a server 210 in accordance with an embodiment of the present invention, there is provided a server 210 in communication with a work source 230, which may comprise a customer or any other entity capable of originating a transmission of work or a contact. The server 210 may be configured in communication with the work source 230 generally via a work source communication means 232, which may comprise any means of communicating data, for example, one or more trunks, phone lines, wireless connections, Bluetooth connections, digital connections, analog connection, combinations thereof, and the like.

In some embodiments of the present invention, the server 210 may also be in communication with a destination 260, which may comprise an agent or any entity capable of receiving a transmission of work or a contact. The server 210 may be configured in communication with the destination 260 generally via an agent communication means 262, which may comprise any means of communicating data, for example, a voice-and-data transmission line such as LAN and/or a circuit switched voice line, wireless connections, Bluetooth connections, digital connections, analog connections, combinations thereof, and the like. The server 210 may comprise any type of computer server, for example, a Basic Call Management System (“BCMS”) and a Call Management System (“CMS”) capable of segmenting work.

The server 210 can be any architecture for directing contacts to one or more telecommunication devices. Illustratively, the server may be a modified in the form of Avaya Inc.'s Definity™ Private-Branch Exchange (PBX)-based ACD system; MultiVantage™ PBX, CRM Central 2000 Server™, Communication Manager™, Business Advocate™, Call Center™, Contact Center Express™, Interaction Center™, and/or S8300™, S8400™, S8500™, and S8700™ servers; or Nortel's Business Communications Manager Intelligent Contact Center™, Contact Center—Express™, Contact Center Manager Server™, Contact Center Portfolio™, and Messaging 100/150 Basic Contact Center™.

In many embodiments, the server 210 may be a stored-program-controlled system that conventionally includes, for example, interfaces to external communication links, a communications switching fabric, service circuits (e.g., tone generators, announcement circuits, and the like.), memory for storing control programs and data, and a processor (i.e., a computer) for executing the stored control programs to control the interfaces and the fabric and to provide automatic contact-distribution functionality. The server 210 generally may include a network interface card (not shown) to provide services to the serviced telecommunication devices.

The server 210 may be configured for segmenting work in the contact center and may comprise an administrative database 244 configured to store at least a common skill option and a service skill option; an administrative graphical user interface (“GUI”) 242 for accessing at least the administrative database 244 and configuring the common skill option and the service skill option; an orchestration system 246 configured to receive a contact from a work source 230 and orchestrate the contact according to a qualification logic stored in a qualification logic database 248; and an assignment engine 250 configured to receive the contact, the common skill option, and the service skill option, and segment the contact according to an assignment logic stored in an assignment logic database 252. In accordance with some embodiments of the present invention, the qualification logic stored in the qualification logic database 248 and the assignment logic stored in the assignment logic database 252 may comprise any logical set of steps or sequences configured to process data at the call center in accordance with any embodiment of the present invention.

The server and/or switch can be a software-controlled system including a processing unit (CPU), microprocessor, or other type of digital data processor executing software or an Application-Specific Integrated Circuit (ASIC) as well as various portions or combinations of such elements.

Methods of processing scores to account for differing conditions have included normalizing the scores by use of statistics such as the average and standard deviation, to produce a normalized distribution. Such methods utilize a single measurement generated by, e.g., an individual person, and compare that single measurement against the normalized distribution. Such normalization has been used transform a simple numeric score or measurement into a weighted value. Such normalization may have usefulness when multiple scores of an item are made by different persons who may have differing subjective measurement scales.

The normalization facilitates comparing scores without requiring that each score be assigned according to a same or a non-subjective scale. For instance, a score of 8 may be marginally meaningful if the average is 7, but would be relatively more significant if the average is 5. Post-normalization to a single distribution, the score of 8 when the average was 5 would be greater, or more significant, than the score of 8 when the average was 7. Normalization of this kind is a step forward, but still lacks a degree of flexibility needed in a contact center environment in which the scores may be produced by multiple scorers, using subjective scoring scales, and having differing levels of importance or weighting.

Methods of processing scores to account for differing conditions have also included an extra initialization process before collecting data about a contact center. In this way, the initialization process can formalize and standardize nomenclature, evaluation categories, etc. Such initialization may be important when collecting and categorizing time-related data. An example of such an initialization process may be described by U.S. Pat. No. 7,720,214 to Ricketts (“Ricketts”).

Embodiments of the present invention provide a methodology to analyze and to evaluate a metric in view of a context of the metric. The context may be used to produce a subjective semantic description, in which the metric is described in relative terms rather than in absolute numeric terms. The subjective semantic description may be processed by fuzzy logic rules.

Fuzzy logic is a tool that can be used to add semantics to each of the current metrics. Fuzzy logic is known as a form of many-valued logic, which deals with reasoning that is fluid or approximate rather than fixed and exact. Fuzzy logic variables may have a truth value that ranges in degree between 0 and 1.

Embodiments of the present invention may provide system and method to use fuzzy logic in analyzing metrics with their contexts to generate contextually rich measurable and comparable values among diverse contact centers. Such embodiments may include the steps of: establishing a metric with respect to a first contact center function; evaluating the metric with respect to a function-specific semantic scale to transform the metric to a second measurement; establishing fuzzy rules to combine second measurements from at least the first contact center function and a second contact center function, to produce a respective fuzzy result per semantic; and analyzing the respective fuzzy result per semantic in order to produce an overall rating value of the contact center service or subset thereof. The overall rating may be, for instance, on scale of 0-10.

Embodiments in accordance with the present invention use fuzzy logic to consolidate multiple metrics into a single metric. Such embodiments are able to interpret natural language statements (e.g., “this is a {good, bad, horrible} contact center”) and processes those statements in order to combine different values generated by evaluation of the contact center (or portions thereof) according to different metrics and/or from different persons. Such an evaluation in accord with embodiments of the present invention can be accomplished by using a straightforward and/or simple numerical analysis to compare values produced according to different metrics and/or different persons.

Embodiments of the present invention do not involve initialization processes such as Ricketts, but rather may include consolidating contact center evaluations that are relevant to different functional parts of the contact center, for instance “number of calls answered” and “collections revenue income.” Embodiments of the present invention may further consolidate those different evaluations into a single metric that will represent an evaluation of the entire contact center. Ricketts describes how to collect data for each individual call on the contact center, whereas embodiments of the present invention work on a relatively higher level of abstraction that supposes the data has already been collected. Embodiments of the present invention furthermore use those previously collected metrics to provide a new metric that can be used to compare different types of contact centers.

An embodiment of the present invention provides an inference engine that enables a user to consolidate major calling center metrics into a single index (i.e., a “health index”) that provides a clear indicator of the current contact center status in real time. The inference engine may operate by use of fuzzy logic rules.

### First Example Scenario

An embodiment of a methodology to evaluate a context, in accordance with the present invention, may be further illustrated by use of a first example scenario described below. The first example scenario is not limiting, and other example scenarios may be possible that are in accordance with embodiments of the present invention.

Assume that a supervisor establishes a set of metrics that he or she considers to be important to the context of their contact center services. Those metrics will be merged later when defining the Fuzzy Rules, as described herein later in greater detail.

Next, assume that the supervisor establishes a “pertaining” function in order to assess the value of a metric within a particular user context. For example, a supervisor in a collections department could establish that two minutes of talk time is “too long,” or that one minute of talk time is a “nice talk time.” Similarly, a supervisor in a customer support department could establish that two minutes talk time is a “nice talk time” and that one minute is a “too short talk time.”

Next, after substantially all pertaining functions are defined, metrics are merged by setting fuzzy rules. The fuzzy rules are readable sentences that include several metrics and lead to conclusions. For example, relating to the collections department, an example fuzzy rule might be: “‘Good Talk Time’ and ‘Short Wrap-up time’ make a ‘Good Contact Center’”. In a further example, relating to the customer support department, an example fuzzy rule might be: “‘Good Talk Time’ or ‘Long Talk Time’ and ‘Middle Wrap-up Time’ make a ‘Good Contact Center’”. The fuzzy rules can be evaluated by computer, thus generating numeric values for each fuzzy rule.

Next, after the fuzzy rules are evaluated, teams from the participating departments (here, Collections and Customer Support) receive a numeric value (i.e., a rating) that rates their assessment of their performance within the contact center. For example, the rating may be set on a scale from 0-10 where 0 means “Terrible Contact Center” and 10 means “Outstanding Contact Center”. An advantage of using ratings worded this way is that the ratings take under consideration the semantics behind each individual metric. The rating can then be comparable among completely different teams and organizations.

Embodiments of the present invention provide a way to compare different calling center organizations by the perspective of their own supervisors, in other words by a rating system and scale that is tailored to the supervisor's department. By way of analogy, it is as if a supervisor could say that he or she is 0.9 happy (on a scale of 0.0-1.0) with their team, and a second supervisor could say that he or she is 0.75 happy with their team. By the foregoing method, which may have the effect of normalizing scores across departments, it can be determined that the first supervisor's team is doing an overall better job than the team under the second supervisor, with the determination supported by measurable and comparable numbers.

### Second Example Scenario

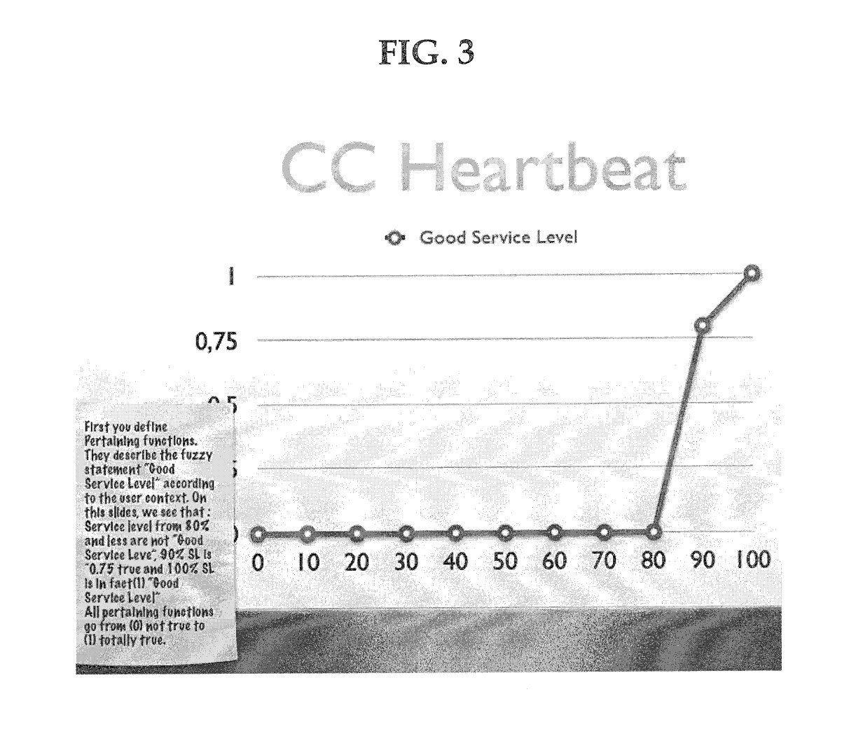

Referring now to FIGS. 3-13, there is illustrated a method in accordance with an embodiment of the present invention. The second example scenario is presented at a relatively lower level of abstraction than the first example scenario. The illustrated embodiment creates an inference engine that enables users of the present invention to consolidate a plurality of contact center metrics into a single measurement, termed here a health or a heartbeat. For instance, the health may range in a standardized range of values, such as from 0 to 10, and therefore provide a clear status indication of the current calling center status in real time. It should be noted that the method illustrated in FIGS. 3-13 is not limiting, and other choices of service levels, semantics, pertaining functions, fuzzy logic relationships, etc., as explained below may be possible, which are in accordance with embodiments of the present invention.

FIG. 3 illustrates, in accordance with an embodiment of the present invention, a fuzzy logic relationship for a metric along the x-axis (in this case, a numeric rating of a service level, e.g., as might be obtained from a customer satisfaction survey) to a determination of a semantic (e.g., a “good” service level) along the y-axis. Such a fuzzy logic relationship may also be referred herein as a pertaining function. The y-axis may also be thought of as a level of agreement, as a function of the metric, to a hypothesis indicated by the semantic (e.g., that the service level was “good”). The y-axis ranges from 0.0 (i.e., entirely untrue) to 1.0 (i.e., entirely true).

For FIGS. 3-5, the metric may be a numeric measurement that is relevant to a single functional area of a contact center. In general, in order to provide contextually rich evaluation, there may be additional graphs, within a single functional area or across functional areas, to describe different relationships between a metric for that functional area and one or more semantic ratings that are relevant to that metric and that functional area, e.g., a “good” service level for a customer service functional area. In general, there will be more than one semantic, and therefore more than one pertaining function, per metric. Although FIGS. 3-5 are illustrated using three semantics (“good,” “acceptable,” and “poor”), other embodiments may use more semantics (e.g., “excellent,” “good,” “acceptable,” “marginal,” and “poor”) or fewer semantics (e.g., “good” and “bad”). There may ordinarily be one pertaining function per combination of metric and semantic.

In one example, for instance fielding initial telephone calls, a relevant metric may refer to a waiting time for incoming calls. In other examples, waiting times may also be a relevant metric for other functional areas but with different fuzzy relationships between the metric and a semantic like a “good” value of the metric. For example, a “good” waiting time may depend on the function, e.g., waiting time for product support resolution, or a waiting time for billing dispute resolution, etc. The different functional areas may have different shapes of a curve relating a metric to a “good” value of that metric. The y-axis provides a semantic interpretation to the metric values, the semantic evaluation being relevant for a single functional area of the contact center.

In the example of FIG. 3, a metric value of 0-80 (on a scale of 0-100) produces a “good” service level value of 0. A metric of 90 produces a “good” service level of 0.75 (i.e., 75%), and a metric of 100 produces a “good” service level of 1.0 (i.e., 100%). In terms of semantics, a “good” service level of 100% may represent complete agreement with the hypothesis that the service level was good. A “good” service level of 75% may represent a lukewarm agreement with the hypothesis that the service level was good. A “good” service level of 0% may represent complete disagreement with the hypothesis that the service level was good.

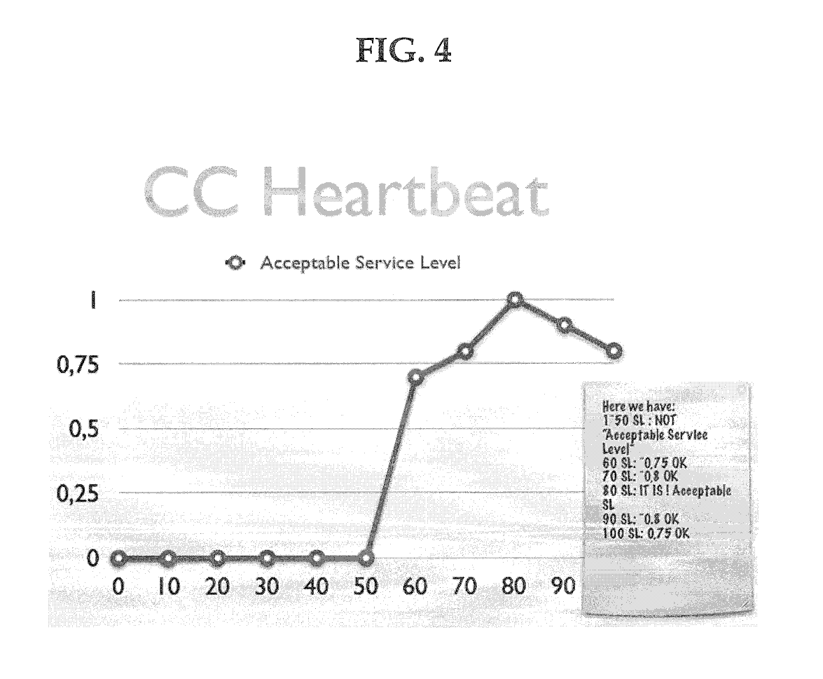

Referring now to FIG. 4, there is illustrated a fuzzy logic relationship for an “acceptable service level” in accordance with an embodiment of the present invention. FIG. 4 relates a metric along the x-axis to a determination of an “acceptable” service level along the y-axis. Similar to FIG. 3, the y-axis of FIG. 4 may also be thought of as a level of agreement, as a function of metric values, to a hypothesis that the service level was “acceptable.” A metric value of 0-50 (on a scale of 0-100) produces an “acceptable” service level value of 0, meaning the hypothesis of acceptable service is untrue for those metric values. However, for metric values between 50 and 100, the “acceptable” service level value reaches a peak value but then decreases as metric approaches 100. This indicates that at high values of the metric, there is less agreement with the hypothesis of “acceptable” service level, because there is greater agreement with the hypothesis of “good” service level. For example, as shown in FIG. 4, a metric of 60 or 80 produces an “acceptable service level” of 0.75 (i.e., 75%), a metric of 70 or 90 produces an “acceptable service level” of 0.80 (i.e., 80%), and a metric of 80 produces an “acceptable service level” of 1.0 (i.e., 100%).

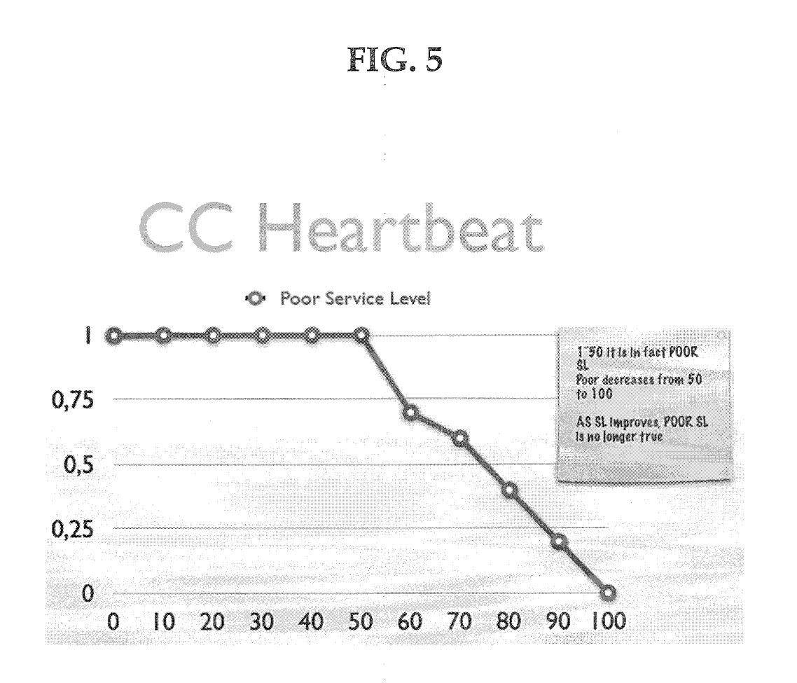

Referring now to FIG. 5, there is illustrated a fuzzy logic relationship for a “poor service level” in accordance with an embodiment of the present invention. FIG. 5 relates a metric along the x-axis to a determination of a “poor” service level along the y-axis. The y-axis may also be thought of as a level of agreement, as a function of metric values, to a hypothesis that the service level was “poor.” A metric value of 0-50 (on a scale of 0-100) produces a “poor service level” value of 1.0 (i.e., 100%), meaning the hypothesis of poor service is true for those metric values. A service level of 50 to 100 produces a “poor service level” that progressively decreases from 1.0 (100%) to 0.0 (0%), indicating a progress disagreement with the hypothesis of “poor” service level as the metric values increase from 50 to 100.

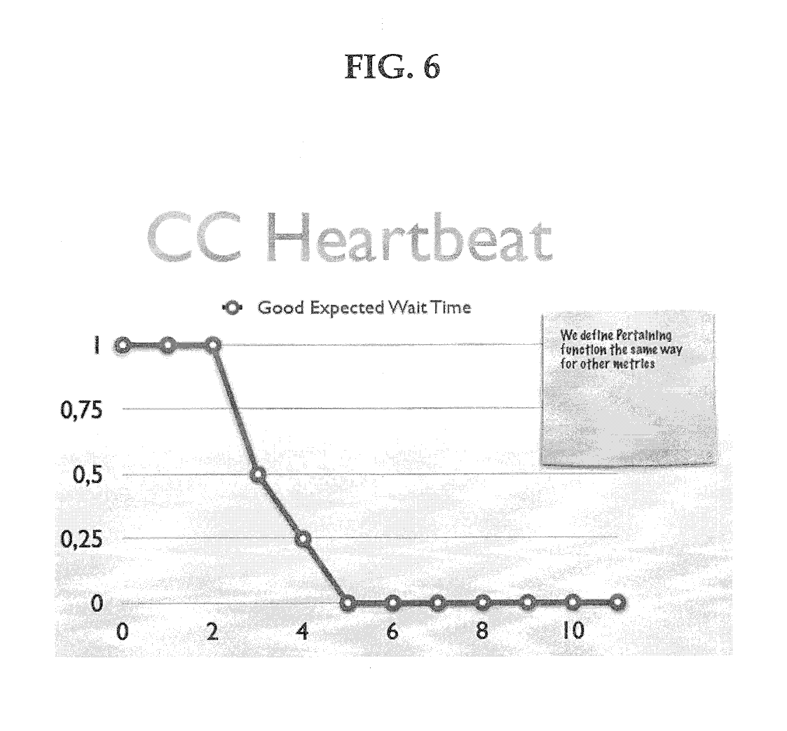

The fuzzy logic relationships presented in FIGS. 3-5 pertain to a functional area of the contact center for which a greater value for the metric variable on the x-axis is generally desirable. FIGS. 6-8, described below, pertain to a different metric, such as from a different functional area of the contact center, the metric being one for which a lesser value of the metric variable on the x-axis is generally desirable.

Referring now to FIG. 6, there is illustrated a fuzzy logic relationship for a “good expected wait time” in accordance with an embodiment of the present invention. FIG. 6 relates a metric along the x-axis (in this case one which is a function of the expected wait time) to a determination of a “good” expected wait time along the y-axis. The y-axis may also be thought of as a level of agreement, as a function of the metric, to a hypothesis that the expected wait time was “good.” An expected wait time value of 0-2 (on a scale of 0-10) produces a “good expected wait time” value of 1.0 (i.e., 100%), meaning the hypothesis of expected wait time is true for those metric values. An expected wait time of 2 to 5 produces a “good expected wait time” that progressively decreases from 1.0 (100%) to 0.0 (0%), indicating a progress disagreement with the hypothesis of “good” expected wait time as the metric values increase from 2 to 5. For metric values of 5 and greater, the “good expected wait time” value is 0.0 (i.e., 0%), indicating complete disagreement with the hypothesis of “good” expected wait time.

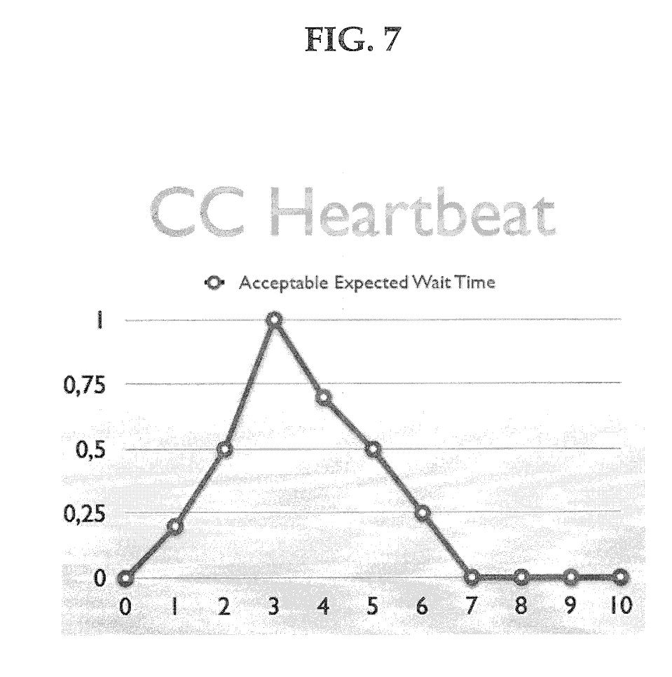

Referring now to FIG. 7, there is illustrated a fuzzy logic relationship for an “acceptable” expected wait time in accordance with an embodiment of the present invention. FIG. 7 relates a metric along the x-axis to a determination of an “acceptable” expected wait time along the y-axis. The y-axis of FIG. 7 may be thought of as a level of agreement, as a function of metric values, to a hypothesis that the expected wait time was “acceptable.”

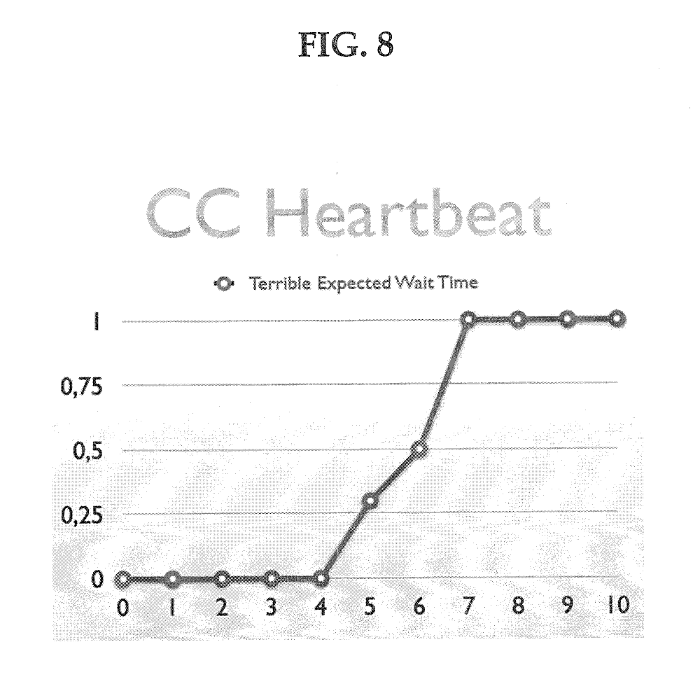

For metric values between 0 and 7, the “acceptable” expected wait time value reaches a peak value but then decreases to 0 as metric approaches 7, and remains at 0 until the metric value reaches 10. This indicates that at low values of the metric, there is less agreement with the hypothesis of “acceptable” expected wait time, because there is greater agreement with the hypothesis of “good” expected wait time. Above the peak value, there is less agreement with the hypothesis of “acceptable” expected wait time because there is greater agreement with the hypothesis of “terrible” wait time, as discussed below in connection with FIG. 8. For example, as shown in FIG. 7, a metric of 1 or 6 produces an “acceptable” expected wait time of about 0.25 (i.e., 25%), a metric of 2 or 5 produces an “acceptable” expected wait time of about 0.50 (i.e., 50%), a metric of 4 produces an “acceptable” expected wait time of 0.75 (i.e., 75%), and a metric of 3 produces an “acceptable” expected wait time of 1.0 (i.e., 100%).

Referring now to FIG. 8, there is illustrated a fuzzy logic relationship for a “terrible” expected wait time in accordance with an embodiment of the present invention. FIG. 8 relates a metric along the x-axis to a determination of a “terrible” expected wait time along the y-axis. The y-axis may also be thought of as a level of agreement, as a function of metric values, to a hypothesis that the service level was “terrible.” A metric value of 0-4 (on a scale of 0-10) produces a “terrible” expected wait time value of 0.0 (i.e., 0%), meaning the hypothesis of terrible expected wait time is untrue for those metric values. A metric value of 4 to 7 produces a “terrible” expected wait time that progressively increases from 0.0 (0%) to 1.0 (100%), indicating a progress agreement with the hypothesis of “terrible” expected wait time as the metric values increase from 4 to 7. At a metric value of 7 to 10, the “terrible” expected wait time value is 1.0 (i.e., 100%), meaning the hypothesis of terrible expected wait time is true for those metric values.

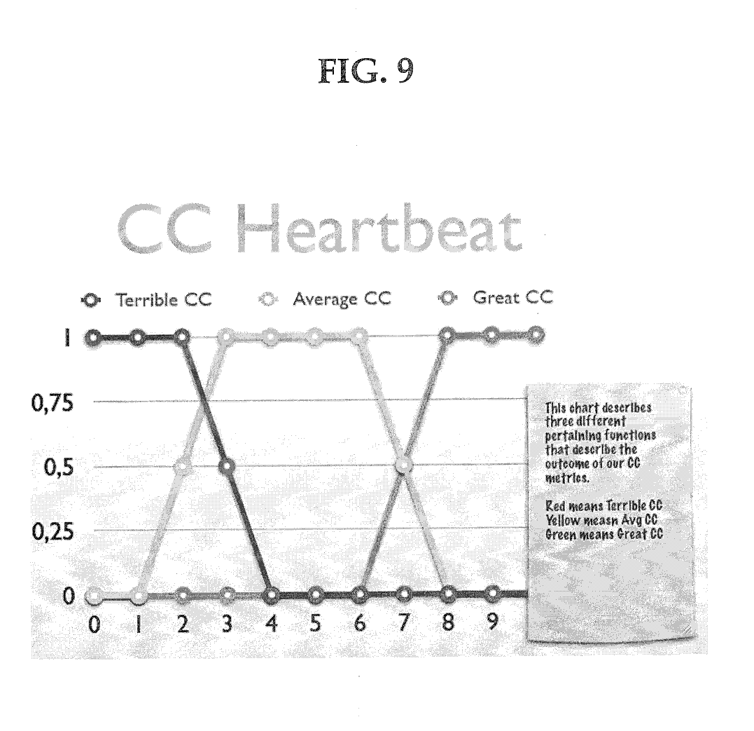

Referring now to FIG. 9, there is illustrated a composite fuzzy logic relationship in accordance with an embodiment of the present invention. The various pertaining functions for a metric in a functional area have been combined into one chart. The combined chart shows what semantic should be assigned to each value of the metric.

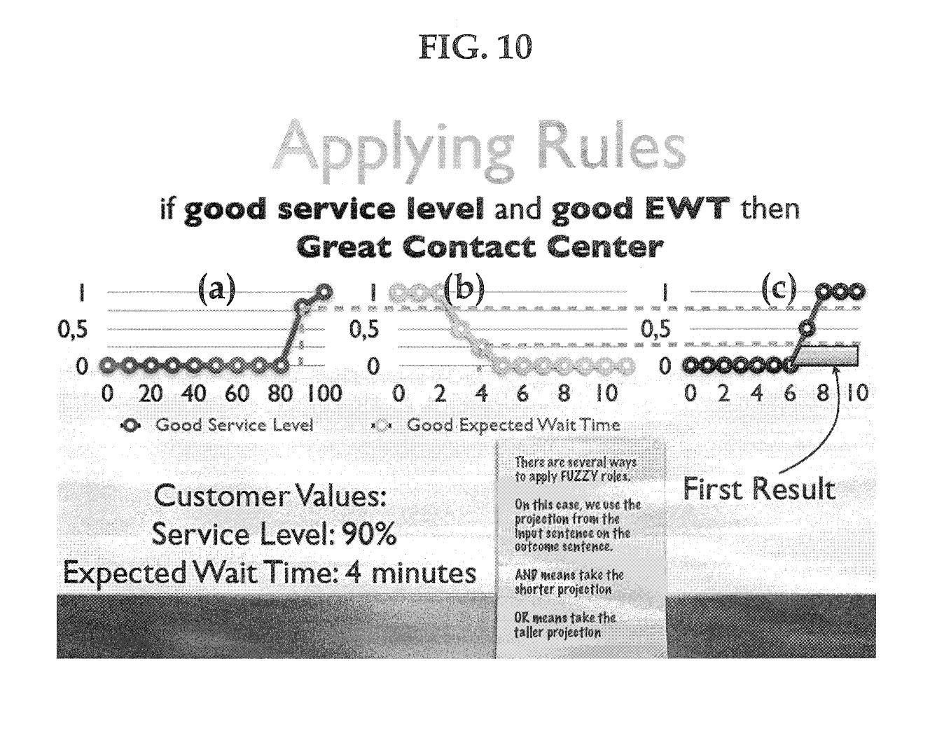

Referring now to FIG. 10, there is illustrated a step of applying the fuzzy logic rules, in accordance with an embodiment of the present invention. Assume that a service level metric is 90% and that an expected wait time (“EWT”) metric is 4 minutes. Further assume that a fuzzy logic rule is that “if ‘good service level’ and ‘good EWT’ then ‘great contact center.’” This maps two pertaining functions (a) and (b) (i.e., “good service level” and “good EWT” onto an output function (c) as marked in FIG. 10. Usage of the conjunction “and” indicates that the lesser of the mappings will be considered, whereas a conjunction of “or” means that the greater of the mappings will be considered. As illustrated by function (c), the fuzzy logic in this example results in a relatively low level of agreement (around 25%) with the proposition of a great contact center. The portion under function (c) marked as “first result” represents a semantic distribution, i.e., a weighting or degree of agreement, assigned to the proposition that the fuzzy logic statement is true, that the contact center is great.

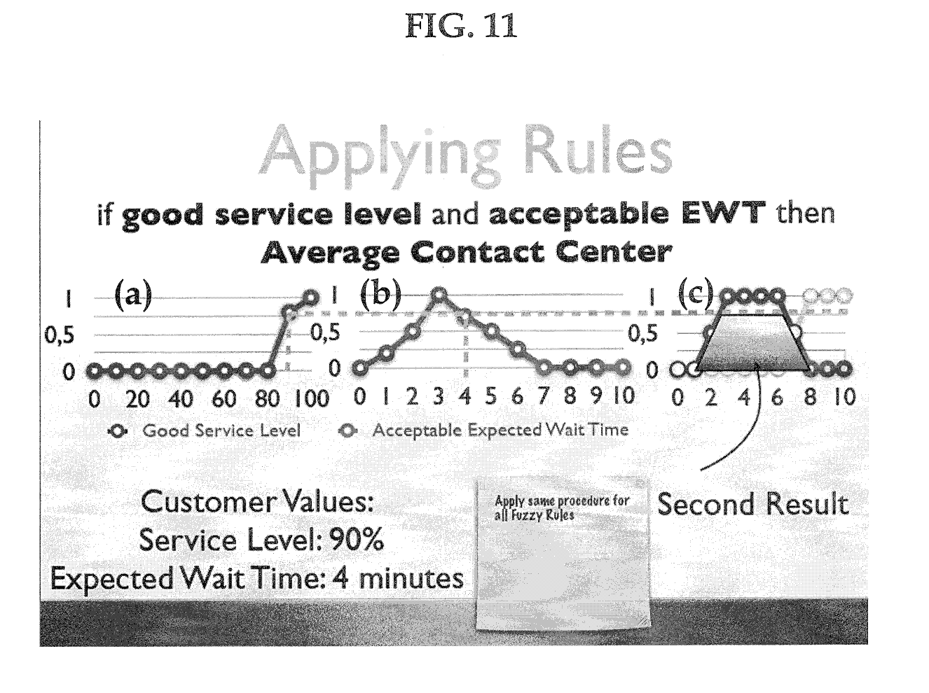

Referring now to FIG. 11, there is illustrated another step of applying the fuzzy logic rules, in accordance with an embodiment of the present invention. As with FIG. 10, assume that a service level metric is 90% and that an expected wait time (“EWT”) metric is 4 minutes. However, assume instead that a fuzzy logic rule is that “if ‘good service level’ and ‘acceptable EWT’ then ‘average contact center’”. This maps two pertaining functions (a) and (b) (i.e., “good service level” and “acceptable EWT” onto an output function (c). As illustrated in FIG. 11, the fuzzy logic in this example results in a relatively higher level of agreement (around 75%) with the proposition of an average contact center. The portion under function (c) marked as “second result” represents a semantic distribution, i.e., a weighting or degree of agreement, assigned to the proposition that the fuzzy logic statement is true, that the contact center is average.

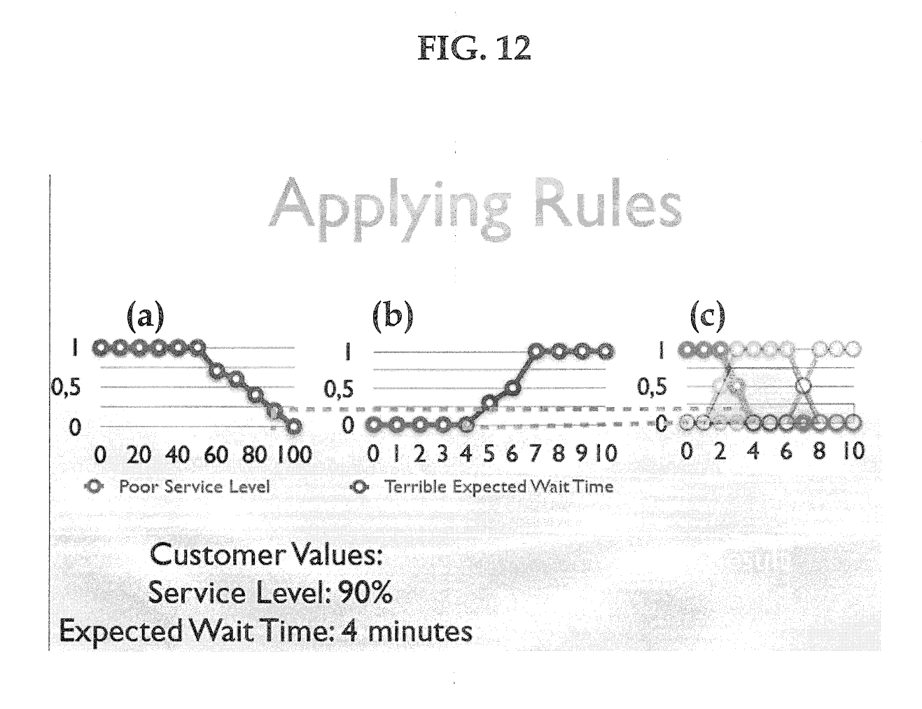

Referring now to FIG. 12, there is illustrated another step of applying the fuzzy logic rules, in accordance with an embodiment of the present invention. As with FIG. 10, assume that a service level metric is 90% and that an expected wait time (“EWT”) metric is 4 minutes. However, assume instead that a fuzzy logic rule is that “if ‘poor service level’ and ‘terrible EWT’ then ‘poor contact center’”. This maps two pertaining functions (a) and (b) (i.e., “poor service level” and “terrible EWT” onto an output function (c). As illustrated in FIG. 12, function (c), the fuzzy logic in this example results in a lower level of agreement with the proposition of a poor contact center, such that an area under the poor service center function (c) is negligible.

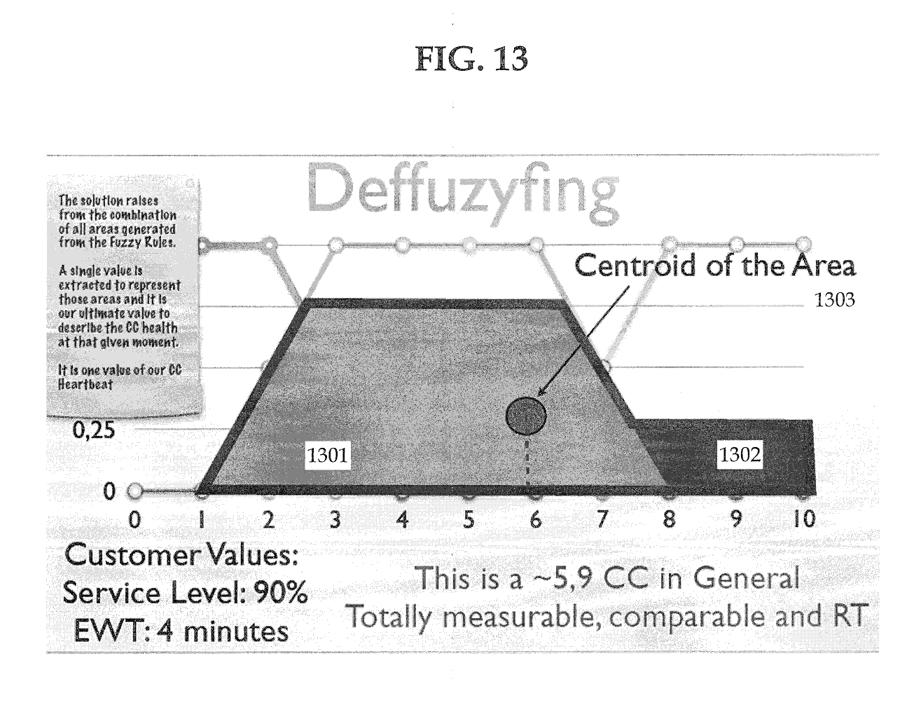

Referring now to FIG. 13, there is illustrated another step of applying the fuzzy logic rules, in accordance with an embodiment of the present invention. FIG. 13 illustrates the solution determined by merging (i.e., combining or forming a superposition of, or forming a merger of) areas 1301, 1302 under the curves and generated from the fuzzy rules. When the areas 1301, 1302 are merged, a final value is calculated as the centroid 1303 of the merged areas 1301, 1302. In the example of FIG. 13, the final value is 5.9. The final value represents a composite rating used to represent, for instance, the health of the contact center.

Embodiments of the present invention include a system having one or more processing units coupled to one or more memories. The one or more memories may be configured to store software that, when executed by the one or more processing unit, allows for the assignment of new work to one of a group of customer service agent near the end of a work shift of at least one customer service agent, such that a likelihood or amount of overtime work is reduced.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method to produce a composite rating using context information, comprising:
measuring a first metric in a first context to provide a first contextual measurement;
measuring a second metric in a second context to provide a second contextual measurement;
transforming the first contextual measurement to a first plurality of semantic context values by use of a first plurality of pertaining functions;
transforming the second contextual measurement to a second plurality of semantic context values by use of a second plurality of pertaining functions;
combining one or more of the first plurality of semantic context values and one or more of the second plurality of semantic context values, by use of one or more fuzzy logic rules, to produce a plurality of semantic distributions; and
calculating a centroid of a merger of the plurality of semantic distributions in order to produce the composite rating.

2. The method of claim 1, wherein the first context is different than the second context.

3. The method of claim 1, wherein a measurement scale of the first metric is different than a measurement scale of the second metric.

4. The method of claim 1, wherein the first plurality of pertaining functions is different than the second plurality of pertaining functions.

5. The method of claim 1, wherein the first and second plurality of semantic context values comprise a quality rating within a respective context.

6. The method of claim 1, wherein the composite rating is a rating of a functional area of a contact center.

7. The method of claim 6, further comprising:
combining the composite rating with a second composite rating of a second functional area of the contact center in order to produce a composite rating of the contact center.

8. A system to produce a rating using heterogeneous context information, comprising:
a first measurement module configured to measure a first metric in a first context to provide a first contextual measurement;
a second measurement module configured to measure a second metric in a second context to provide a second contextual measurement;
a first transformation module configured to transform the first contextual measurement to a first plurality of semantic context values by use of a first plurality of pertaining functions;
a second transformation module configured to transform the second contextual measurement to a second plurality of semantic context values by use of a second plurality of pertaining functions;
a combiner configured to combine one or more of the first plurality of semantic context values and one or more of the second plurality of semantic context values, by use of one or more fuzzy logic rules, to produce a plurality of semantic distributions; and
a processor configured to calculate a centroid of a merger of the plurality of semantic distributions in order to produce the composite rating.

9. The system of claim 8, wherein the first context is different than the second context.

10. The system of claim 8, wherein a measurement scale of the first metric is different than a measurement scale of the second metric.

11. The system of claim 8, wherein the first plurality of pertaining functions is different than the second plurality of pertaining functions.

12. The system of claim 8, wherein the first and second plurality of semantic context values comprise a quality rating within a respective context.

13. The system of claim 8, wherein the composite rating is a rating of a functional area of a contact center.

14. The system of claim 13, wherein the combiner is further configured to combine the composite rating with a second composite rating of a second functional area of the contact center in order to produce a composite rating of the contact center.

15. A system, comprising a computer server, the computer server comprising a tangible computer readable medium comprising program instructions, wherein the program instructions are computer-executable to implement:
measuring a first metric in a first context to provide a first contextual measurement;
measuring a second metric in a second context to provide a second contextual measurement;
transforming the first contextual measurement to a first plurality of semantic context values by use of a first plurality of pertaining functions;
transforming the second contextual measurement to a second plurality of semantic context values by use of a second plurality of pertaining functions;
combining one or more of the first plurality of semantic context values and one or more of the second plurality of semantic context values, by use of one or more fuzzy logic rules, to produce a plurality of semantic distributions; and
calculating a centroid of a merger of the plurality of semantic distributions in order to produce the composite rating.

16. The system of claim 15, wherein the first context is different than the second context.

17. The system of claim 15, wherein a measurement scale of the first metric is different than a measurement scale of the second metric.

18. The system of claim 15, wherein the first plurality of pertaining functions is different than the second plurality of pertaining functions.

19. The system of claim 15, wherein the composite rating is a rating of a functional area of a contact center.

20. The system of claim 19, wherein the combiner is further configured to combine the composite rating with a second composite rating of a second functional area of the contact center in order to produce a composite rating of the contact center.
